(19) United States
(12) Patent Application Publication
(10) Pub. No.: US 2007/0254805 A1
(43) Pub. Date: Nov. 1, 2007

(54) Reforming Catalyst

(76) Inventors: Mark Robert Feaviour, Reading (GB); Jillian Elaine Bailie, Reading (GB)

Correspondence Address: RATNERPRESTIA, P O BOX 980, VALLEY FORGE, PA, 19482-0980, US

(21) Appl. No.: 10/582,373

(22) PCT Filed: Dec. 7, 2004
(86) PCT No.: PCT/GB04/05141

§ 371 Date: Mar. 5, 2007

(30) Foreign Application Priority Data
Dec. 11, 2003 (GB) 0328649.9

(51) Int. Cl. B01J 21/06

(52) U.S. Cl. 502/304

(57) ABSTRACT

A reforming catalyst comprising precious metal particles dispersed on a support material, wherein the support material comprises ceria, and characterised in that the support material further comprises magnesium aluminate is disclosed. Catalysed components and fuel processing systems comprising the catalyst, and reforming processes using the catalyst are also disclosed.

The present invention relates to fuel reforming catalysts, catalysed components and fuel processing systems comprising the catalysts, and reforming processes using the catalysts.

Hydrogen is an important industrial gas and is used in a number of applications such as ammonia synthesis, methanol synthesis, chemical hydrogenations, metal manufacture, glass processing and fuel cells. Fuel processors produce hydrogen by reforming fuels such as methane, propane, methanol, ethanol, natural gas, liquefied petroleum gas (LPG), diesel and gasoline, and are used to provide hydrogen for a variety of applications, particularly for fuel cells. The reforming process produces a hydrogen-rich reformate stream that also comprises carbon dioxide, carbon monoxide and trace amounts of hydrocarbons or alcohols. Carbon monoxide is a severe poison for the catalysts in the anode of a fuel cell, so fuel processing systems generally comprise a fuel reformer and one or more carbon monoxide clean-up stages.

In a steam reforming process, water and fuel are combined to produce hydrogen and carbon dioxide, e.g. for methanol:
CH₃OH+H₂O→CO₂+3H₂
This process is endothermic, so steam reforming requires a continuous input of energy. In an autothermal reforming process, both water and air are mixed with the fuel. The process combines steam reforming and partial oxidation, e.g. for methanol:
CH₃OH+H₂O→CO₂+3H₂
CH₃OH+½O₂→CO₂+2H₂
The partial oxidation is exothermic, thus providing the heat for the endothermic steam reforming reaction. Another reaction which may take place within the autothermal reformer is the water gas shift reaction:
CO+H₂O→CO₂+H₂
This is a particularly useful reaction because it reduces CO content and increases hydrogen content. Autothermal reforming processes are described in WO 96/00186.

Catalysts are used to promote the various reforming reactions. Generally the catalysts comprise metal particles deposited on ceramic support materials. A commonly used support material is y-Al₂O₃ due to its mechanical stability, moderately high surface area, resistance to sintering over a wide range of temperatures and high degree of metal dispersion that can be achieved. EP 1 157 968 discloses a catalyst for use in autothermal reforming reactions that contains rhodium and optionally platinum on support containing 5 to 40% by mass of cerium oxide, 60 to 95% by mass of an aluminium oxide and 0 to 10% by mass of an alkali metal or alkaline earth metal.

The present inventors have sought to provide an improved reforming catalyst. Desirably the catalyst should promote the reforming reactions over a wide temperature range and for a variety of fuels, including sulphur-containing fuels. The catalyst should be durable, i.e. the performance should not decrease significantly with time.

Accordingly the present invention provides a reforming catalyst comprising precious metal particles dispersed on a support material, wherein the support material comprises ceria, and characterised in that the support material further comprises magnesium aluminate.

The present inventors have found that the catalysts according to the invention have improved performance when compared to catalysts comprising state-of-the-art support materials.

The magnesium aluminate is suitably a crystalline compound with the spinel structure and the formula MgAl₂O₄. The support material may further comprise magnesium oxide. The magnesium oxide is suitably a crystalline compound with the periclase structure. Suitably the support material contains at least 20wt % magnesium aluminate or 20wt % magnesium aluminate and magnesium oxide, and preferably at least 35 wt % magnesium aluminate or 35 wt % magnesium aluminate and magnesium oxide, compared to the total mass of the support material.

If the support material comprises both magnesium aluminate and magnesium oxide, the molar ratio of magnesium aluminate to magnesium oxide is suitably between 15:1 and 1:15, preferably between 12:1 and 1:6. In a preferred embodiment, the support material is made by a process wherein aluminium magnesium hydroxycarbonate is calcined to form a mixture of magnesium oxide and magnesium aluminate. In this embodiment, the magnesium aluminate and magnesium oxide are intimately mixed. Suitably the combined mass of magnesium aluminate and magnesium oxide is 40-90 wt % compared to the total mass of the support material.

In one embodiment of the invention, the support material further comprises zirconia. The loading of ceria and zirconia (i.e. the combined mass of the ceria and the zirconia as a percentage of the total mass of the support material) is suitably 10-60 wt %, preferably 25-60 wt %. The ceria and zirconia may be present as regions of ceria, regions of zirconia and/or regions of mixed ceria-zirconia oxide. It is preferred that the majority of the ceria and zirconia is present as the mixed oxide. The atomic ratio of ceria:zirconia is suitably in the range from 10:1 to 1:10, preferably from 5:1 to 1:1, most preferably about 3:1.

In another embodiment of the invention, the support material further comprises iron oxide and/or chromium oxide, preferably chromium oxide. The loading of ceria and iron oxide/chromium oxide (i.e. the combined mass of the ceria and the iron oxide/chromium oxide as a percentage of the total mass of the support material) is suitably 10-60 wt %, preferably 25-60 wt %. The ceria and iron oxide/chromium oxide may be present as regions of ceria, regions of iron oxide or chromium oxide and/or regions of mixed ceria-iron oxide or ceria-chromium oxide (and/or regions of mixed ceria-iron oxide-chromium oxide if the support comprises both iron and chromium oxides). It is preferred that the majority of the ceria and iron oxide or chromium oxide is not present as mixed oxides, but is present as regions of ceria and regions of iron oxide or chromium oxide. The atomic ratio of ceria:iron oxide and/or chromium oxide is suitably in the range from 1:20 to 20:1, preferably from 9:1 to 1:9 and most preferably from 7:3 and 3:7.

Suitably the support material comprises ceria and optionally zirconia, iron oxide or chromium oxide dispersed on the surface of a magnesium aluminate material that may be magnesium aluminate alone or may be a mixed magnesium aluminate/magnesium oxide material. The average particle size of the ceria/zirconia/iron oxide/chromium oxide particles on the surface of the magnesium aluminate material is suitably below 15 nm, preferably below 8 nm.

The support material of the as-prepared catalyst (before it is used to catalyse a reforming reaction) suitably has a surface area greater than 80 m²/g and preferably between 100 and 200 m²/g.

The precious metal particles suitably comprise rhodium, ruthenium or platinum. The precious metal particles may be rhodium, ruthenium or platinum alone, or may be alloy particles comprising one or more of rhodium, ruthenium and platinum. Suitable alloying metals include other precious metals such as palladium, osmium or iridium, but may also include base metals. In a preferred embodiment the precious metal particles are rhodium particles or platinum-rhodium alloy particles. In a particularly preferred embodiment the precious metal particles are rhodium particles.

The precious metal particles are dispersed on the support material. When the support material comprises ceria and optionally zirconia/iron oxide/chromium oxide dispersed on a magnesium aluminate material, the precious metal particles may be deposited on the magnesium aluminate material, on the ceria/zirconia/iron oxide/chromium oxide particles and/or at the interfaces of the ceria/zirconia/iron oxide/chromium oxide particles and the magnesium aluminate material.

Suitably the loading of the precious metal particles is 0.5-10 weight %, based on the weight of the support material. If the precious metal particles are platinum-rhodium alloy particles, a suitable atomic ratio of platinum:rhodium is between 5:1 and 1:5, preferably about 1:1.

In a preferred embodiment, the reforming catalyst further comprises an alkali metal or alkaline earth metal promoter, preferably lithium. The promoter is deposited on the surface of the support material and is preferably alloyed with the precious metal particles. The atomic ratio of precious metal particles to promoter material is suitably between 20:1 and 5:1.

In another preferred embodiment, the reforming catalyst further comprises gold as a promoter. The gold is suitably not alloyed with the catalytic precious metal particles, but is present as gold particles that are dispersed, with the precious metal particles, on the surface of the support material.

The catalyst may be prepared by any suitable methods known to those skilled in the art. Suitable methods include co-impregnation, deposition precipitation and co-precipitation procedures.

A suitable method for preparing the support material is the deposition of ceria and optionally zirconia/iron oxide/chromium oxide onto a magnesium aluminate material by co-precipitation. The magnesium aluminate material could be magnesium aluminate, or a magnesium aluminate/magnesium oxide mixture produced by calcining aluminium magnesium hydroxycarbonate. In one suitable method, sols of ceria and zirconia, which are stabilised by counter ions such as nitrate and acetate, are added to a slurry of a magnesium aluminate material. A base such as 1M ammonia solution is added to the slurry. The product is then washed several times, dried, e.g. at 120° C. and calcined, e.g. at 800° C. In another suitable method, an aqueous solution of cerium and iron/chromium salts, e.g. the nitrate salts, is added drop-wise to a basic slurry of a magnesium aluminate material. The product is isolated by filtration, washed several times, dried, e.g. at 120° C. and calcined, e.g. at 800° C.

A suitable method for the deposition of the precious metal particles onto the support material is incipient wetness impregnation. Suitable metal salts are made up into a solution such that the volume of solution is sufficient to fill the entire pore volume of the support material. The solution is added to the support material, the material is mixed thoroughly and then dried and calcined.

Another suitable method for the deposition of the precious metal particles is co-deposition. The support material is dispersed in a slurry containing suitable precious metal salts. A base is added to deposit the metal onto the support material, and the catalyst is dried and calcined.

In a further aspect, the present invention provides a catalysed component comprising the reforming catalyst according to the invention. The catalysed component comprises the reforming catalyst deposited on a suitable substrate. The substrate may be any suitable flow-through substrate such as a monolith, foam, static mixer or heat exchanger unit. Alternatively the substrate may comprise discrete units such as pellets, rings etc. which are enclosed in a container. The substrate may be ceramic, e.g. cordierite, or metallic. The amount of catalyst on the substrate is suitably from 0.5-5 g/in³ (0.03-0.3 g/cm³).

The catalyst is deposited on the substrate using any appropriate techniques known to those skilled in the art. Suitably, the catalyst is dispersed in water, possibly with additional binders, thickeners or adhesive agents to form a slurry. It is usually necessary to break down the particle size of the catalyst by milling the slurry, e.g. in a ball mill or a bead mill, or by milling the dry catalyst before it is added to the slurry, e.g. in a jet mill. The slurry is passed over or through the substrate to coat the surfaces that will be exposed to the reactant gases. This can be done by dip coating, flood coating or waterfall coating. These and other methods, such as vacuum impregnation, are well known in the art. Any excess slurry is removed, and the substrate is subsequently dried and calcined.

In a yet further aspect, the present invention provides a process for reforming fuel using a catalyst or catalysed component according to the invention. The process comprises the step of supplying fuel, steam and optionally air to the catalyst or catalysed component. The fuel may be an alkane such as methane, an alcohol such as methanol or a mixture of components, such as gasoline. In one embodiment of the invention, the fuel comprises sulphur compounds. Liquid fuels must be vaporised before they are supplied to the catalysed component. If the process uses steam reforming (and not autothermal reforming), heat must be supplied to the reaction or to the catalysed component, e.g. by pre-heating the fuel and/or steam. The reforming process is typically carried out at temperatures above 600° C.

In a yet further aspect, the present invention provides a fuel processing system comprising a catalyst or catalysed component according to the invention. The system may further comprise carbon monoxide clean-up components (e.g. water gas shift reactors, selective oxidation reactors, hydrogen diffusion membranes), heat exchanger components and catalytic burners.

The invention will now be described by reference to examples which are not meant to be limiting thereof.

### Catalyst Manufacture

Eight catalysts based on eight different support materials were prepared:

| | | MgAl₂O₄:MgO |
|---|---|---|
| | Support Material | molar ratio |
| Comparative | 30 wt % Ce_{0.75}Zr_{0.25}O₂ on Al₂O₃ | N/A |
| Example 1 | | |
| Comparative | Calcined Pural MG30 | 11.80 |
| Example 2 | | |
| Example 1 | 30 wt % Ce_{0.75}Zr_{0.25}O₂ on calcined | 11.80 |
| | Pural MG30 | |
| Example 2 | 30 wt % Ce_{0.75}Zr_{0.25}O₂ on calcined | 0.65 |
| | Pural MG50 | |
| Example 3 | 30 wt % Ce_{0.75}Zr_{0.25}O₂ on calcined | 0.20 |
| | Pural MG70 | |
| Example 4 | 30 wt % Ce_{0.75}Zr_{0.25}O₂ on MgAl₂O₄ | N/A |
| Example 5 | 30 wt % CeO₂/Cr₂O₃ (1:1 Ce:Cr) on | 11.80 |
| | calcined Pural MG30 | |
| Example 6 | 30 wt % CeO₂/Cr₂O₃ (1:1 Ce:Cr) on | 0.65 |
| | calcined Pural MG50 | |

NB: The term Ce_{0.75}Zr_{0.25}O₂ is used for the ceria-zirconia materials because the ceria and zirconia are predominantly present as the mixed oxide. The term CeO₂/Cr₂O₃ is used for the ceria-chromium oxide materials because the ceria and chromium oxide are predominantly present as individual oxides.

The alumina, Pural materials and magnesium aluminate were purchased from Sasol GmbH (Brunsbuettel, Germany). The Pural materials are aluminium magnesium hydroxycarbonates and the MG30, MG50 and MG70 materials have metal contents equivalent to 30:70, 50:50 and 70:30 weight mixtures of MgO and Al₂O₃. The Pural materials were calcined at 800° C. to form mixtures of MgO and MgAl₂O₄. X-ray diffraction confirmed that the calcined materials contained only crystalline MgO (periclase structure) and crystalline MgAl₂O₄ (spinel structure). The MgAl₂O₄:MgO molar ratio was calculated from the known amounts of magnesium and aluminium in the starting materials.

To provide the support materials for the catalysts of Comparative Examples 1 and lo Examples 1-4, the alumina, Pural materials or magnesium aluminate were slurried in demineralised water and nitrate-stabilised ceria and zirconia sols were added. Ammonia solution (IM) was added until the pH of the slurry reached 8. The product was filtered and washed several times to remove NH₄NO₃ and then dried at 120° C. for 8 hours and calcined at 800° C. for 2 hours. The support material had a loading of 30 wt % of ceria-zirconia.

To provide the support material for the catalysts of Examples 5 and 6, the alumina and Pural materials were slurried in a mixture of ammonia solution (4M) and demineralised water. Cr(NO₃)₃.9H₂O was dissolved in demineralised water and added to Ce^{(IV)} nitrate solution. The mixed nitrate solution was added drop-wise to the slurry and the pH was monitored. After nitrate solution addition the pH was close to 8 and the product was isolated by filtration. The product was washed several times to remove NH₄NO₃ and was then dried at 120° C. for 8 hours and calcined at 800° C. for 2 hours. Each support material had a loading of 30 wt % of ceria and chromium oxide. The ratio of cerium:chromium was 1:1.

A rhodium loading of 2 wt % was deposited on each support material by incipient wetness impregnation. Rhodium nitrate (Johnson Matthey, UK) was made up into an aqueous solution such that the volume of solution was sufficient to fill the entire pore volume of the support material. The solution was added to the support material, the material was mixed and then the material was dried at 120° C. for 8 hours and calcined at 500° C. for 2 hours.

### Performance Tests: Gasoline Steam Reforming

The catalysts of Comparative Examples 1 and 2 and Examples 1-4 and 6 were tested for their ability to catalyse the steam reforming of gasoline. Catalyst powder samples were diluted with cordierite (10:1 cordierite:catalyst) and pelletised (250-355 μm). 100 mg of the pelletised samples were tested in a continuous flow, fixed-bed microreactor.

Gasoline steam reforming performance of the catalysts of was measured at atmospheric pressure and a furnace temperature of 700° C. The fuel flow was 1.9 ml/h and the H₂O:C ratio was 4. Nitrogen was used as a diluent at 100 ml/min.

Conversion to CO, CO₂ and CH₄ and the NMHC level (residual non-methane hydrocarbon as Cl equivalents in dry gas flow) were measured. The NMHC level is considered to be a more sensitive indicator of performance than conversion to Cl components. Lower NMHC levels indicate better performance.

| | % Conversion to | |
|---|---|---|
| | CO + CO₂ + CH₄ | NMHC/ppm |
| Comparative | 71.9 | 51150 |
| Example 1 | | |
| Comparative | 82.1 | 31817 |
| Example 2 | | |
| Example 1 | 93.1 | 11760 |
| Example 2 | 94.1 | 9600 |
| Example 3 | 87.8 | 21390 |
| Example 4 | 87.9 | 20280 |
| Example 6 | 91.1 | 15167 |

The catalysts of examples 1-4 and 6 have better performance than a state-of-the-art catalyst wherein the support comprises ceria and alumina (comparative example 1) when reforming gasoline. They also have better performance than a catalyst wherein the support comprises magnesium aluminate but does not comprise ceria (comparative example 2).

### Performance Tests: Dodecane Steam Reforming

Several catalysts were tested for their ability to catalyse the steam reforming of dodecane with and without 10 ppm sulphur (the dodecane is doped with thiophene). These fuels are models for sulphur-containing and sulphur-free diesel. Catalyst powder samples were diluted with cordierite (5:1 cordierite:catalyst) and pelletised (250-355 μm). 100 mg of the pelletised samples were tested in a continuous flow, fixed-bed microreactor.

Steam reforming performance of the catalysts was measured at atmospheric pressure. The fuel flow was 1.6 ml/h and the H₂O:C ratio was 4. Nitrogen was used as a diluent at 25 ml/min. Conversion to CO, CO₂ and CH₄ was measured.

The catalysts of comparative example 1, example 2 and example 6 were tested with sulphur-containing dodecane at 775° C.:

| | % Conversion of dodecane (+10 ppm S) |
|---|---|
| | to CO + CO₂ + CH₄ |
| Comparative Example 1 | 43.9 |
| Example 2 | 44.4 |
| Example 6 | 52.1 |

The catalyst of example 2 has similar performance to the state-of-the-art catalyst (comparative example 1). The catalyst of example 6, which contains ceria, chromia and magnesium aluminate has significantly better performance for reforming sulphur-containing dodecane when compared to comparative example 1.

The catalysts of comparative example 2, example 5 and example 6 were tested with dodecane and sulphur-containing dodecane at 800° C.:

| | % Conversion of | % Conversion of |
|---|---|---|
| | dodecane (no S) to | dodecane (+10 ppm S) |
| | CO + CO₂ + CH₄ | to CO + CO₂ + CH₄ |
| Comparative | 84.4 | 59.6 |
| Example 2 | | |
| Example 5 | 96.1 | 61.4 |
| Example 6 | 82.8 | 62.3 |

The catalysts of example 5 shows particularly good performance for the conversion of sulphur-free dodecane and the catalysts of examples 5 and 6 are both very effective at reforming dodecane in the presence of sulphur.

1. A reforming catalyst comprising precious metal particles dispersed X on a support material, wherein the support material comprises ceria and magnesium aluminate.

2. A reforming catalyst according to claim 1, wherein the support material further comprises magnesium oxide.

3. A reforming catalyst according to claim 2, wherein the molar ratio of magnesium aluminate to magnesium oxide is between 15:1 and 1:15.

4. A reforming catalyst according to claim 1, wherein the support material contains at least 20 wt % magnesium aluminate or at least 20 wt % magnesium aluminate and magnesium oxide, based on the weight of the support material.

5. A reforming catalyst according to claim 1, wherein the support material is made by a process wherein aluminium magnesium hydroxycarbonate is calcined to form a mixture of magnesium oxide and magnesium aluminate.

6. A reforming catalyst according to claim 1, wherein the support material further comprises zirconia.

7. A reforming catalyst according to claim 1, wherein the support material further comprises iron oxide.

8. A reforming catalyst according to claim 1, wherein the support material further comprises chromium oxide.

9. A reforming catalyst according to claim 1, wherein the support material comprises ceria dispersed on the surface of magnesium aluminate or a mixed magnesium aluminate/magnesium oxide material.

10. A reforming catalyst according to claim 1, wherein the support material comprises ceria and chromium oxide dispersed on the surface of magnesium aluminate or a mixed magnesium aluminate/magnesium oxide material.

11. A reforming catalyst according to claim 1, wherein the support material consists essentially of ceria and chromium oxide dispersed on the surface of magnesium aluminate or a mixed magnesium aluminate/magnesium oxide material.

12. A reforming catalyst according to claim 1, wherein the precious metal particles are selected from the group consisting of rhodium, ruthenium and platinum.

13. A catalysed component comprising a reforming catalyst according to claim 1 deposited on a substrate.

14. A process for reforming fuel comprising a step of supplying fuel and steam to a catalysed component comprising a reforming catalyst comprising precious metal particles dispersed on a support material, wherein the support material comprises ceria and magnesium aluminate.

15. A process for reforming fuel comprising a step of supplying fuel and steam to a catalyst comprising precious metal particles dispersed on a support material, wherein the support material comprises ceria and magnesium aluminate.

16. A fuel processing system comprising a catalysed component according to claim 13.

17. A fuel processing system comprising a catalyst according to claim 1.

18. A process according to claim 14, wherein the supplying step further comprises supplying air, along with the fuel and steam, to the catalysed component.

19. A process according to claim 15, wherein the supplying step further comprises supplying air, along with the fuel and steam, to the catalyst.

20. A reforming catalyst according to claim 9, wherein the support material further comprises at least one of zirconia, iron oxide or chromium oxide dispersed, along with the ceria, on the surface of magnesium aluminate or a mixed magnesium aluminate/magnesium oxide material.
